(19) United States
(12) Patent Application Publication
(10) Pub. No.: US 2026/0328046 A1
(43) Pub. Date: Oct. 22, 2026

(54) ENERGY SAVINGS CONVERSION SYSTEM FOR SINGLE GLAZED WINDOWS

(71) Applicant: Mechoshade Systems, LLC, Middleton, WI (US)

(72) Inventors: Jay Reyher, Long Island City, NY (US); Tom Culp, Long Island City, NY (US); Stephen Hebeisen, Amawalk, NY (US); Dylan Schmied, Long Island City, NY (US); Michael Graybar, Long Island City, NY (US)

(73) Assignee: Mechoshade Systems, LLC, Middleton, WI (US)

(21) Appl. No.: 19/648,473

(22) Filed: Apr. 15, 2026

Related U.S. Application Data
(60) Provisional application No. 63/790,559, filed on Apr. 17, 2025.

(51) Int. Cl. E06B 3/30; E06B 9/24

(52) U.S. Cl. CPC E06B 3/301; E06B 9/24

(57) ABSTRACT

The system may comprise, for example, a first bracket configured to hold a cassette; the cassette comprising gearing, wherein the cassette is configured to adjust a window shade; a second bracket comprising a holder; and a secondary glazing configured to be held within the holder, wherein the first bracket and the second bracket are configured to be mounted within a window shade pocket next to a first glazing.

### CROSS-REFERENCE TO RELATED APPLICATIONS

This application claims priority to and the benefit of U.S. Provisional Patent Application No. 63/790,559 filed Apr. 17, 2025 and entitled “ENERGY SAVINGS CONVERSION SYSTEM FOR SINGLE GLAZED WINDOWS” which is incorporated herein by reference in its entirety for all purposes.

### FIELD

The system generally improves energy savings of single glazed punched windows without replacement. More particularly, the system adds a window shade and a second glazing near a first glazing (single glazed punched window), to eliminate the need to upgrade the first glazing and its components, while increasing overall energy performance and comfort.

### BACKGROUND

Buildings typically use a large amount of energy, so contractors and building owners are always looking for innovative solutions to provide more energy savings in buildings. In that regard, certain areas of a building such as the windows and window shades may provide different opportunities to harness or save energy.

Many older structures include single pane windows with only one layer of glass. In fact, about 60% of glass in commercial buildings is still single pane. Moreover, windows comprise a significant amount of the façade on some commercial buildings, which often results in increased exposure to the outdoor environment. Single pane windows do not have an extra pane of glass that can help resist the entry of light or noise. The single pane windows reduce the energy efficiency of the structure due to the solar rays entering the window and providing unwanted solar heat gain inside the structure in the summer time. Moreover, the single pane windows do not provide sufficient insulation from the outside elements (cold air in the winter and warm air in the summer) entering the structure. Single pane windows also experience more noise pollution and more condensation.

Extra insulation often helps maintain the inner climate of a building by reducing the load on the HVAC system. Better insulation quality of the window glass also ensures enhanced convenience in all seasons. The extra insulation may be achieved by the use of a double-pane window. A double-pane window has two layers of glass with a space filled with air or gas in between. The double-pane window provides significantly better insulation compared to a single-pane window, such that double-pane windows are typically more energy efficient and better at regulating indoor temperatures. Double-pane windows usually provide much better thermal protection against heat transfer from the outside to the inside of the structure. Double-pane windows are typically considered more energy efficient as the double-pane windows reduce heat loss and gain, leading to lower energy bills.

However, even with double-pane windows, the heat gain can build up between the panes and enter into the structure. For example, a space between a window and a window covering (e.g., window shade) may often experience solar heat gain through conduction of the solar heat from the outside of the window and through the window into such a space. A window shade in the partially or fully down position may trap some or all of the solar rays from the sun in the space due to conduction. As such, the trapped air between the window and the window shade experiences the solar heat gain. Minor losses of the heat may occur from conduction through the window and back to the outside. Minor losses of the heat may also occur from conduction through the window shade and from convection through the air into the room. However, the bulk of the solar heat gain that is trapped between the window and the window shade rises into the window shade pocket, and such solar heat gain may typically hurt energy conservation efforts. As such, a strong need exists to convert single pane windows to a double-pane window system. A need also exists to block the heat gain that enters into the structure from the outside.

### SUMMARY

In various embodiments, the system may comprise, for example, a first bracket configured to hold a cassette; the cassette comprising gearing, wherein the cassette is configured to adjust a window shade; a second bracket comprising a holder; and a secondary glazing configured to be held within the holder, wherein the first bracket and the second bracket are configured to be mounted within a window shade pocket next to a first glazing.

In various embodiments, the system may comprise, for example, the secondary glazing including one or more glazings. A channel may be configured to provide a path for a cable from a motor that interfaces with the cassette. The first bracket and the second bracket may be integrated together. The first glazing may be a single pane window. At least a portion of the first bracket and the second bracket may be sealed against the window shade pocket. The cassette may at least one of comprise or interface with a motor. The cassette may further comprise at least one of a chain, a lever or a wand. The window shade may be a cellular shade, tilt blind, louver shade or roller shade. The holder may be a C-shaped clamp.

In various embodiments, the first glazing may be on a first side of the second bracket with the holder and the first bracket with the cassette is on a second side of the second bracket with the holder. The second bracket with the holder may be between the first glazing and the first bracket with the cassette. The first bracket with the cassette may be between the first glazing and the second bracket with the holder. The second glazing may be between the first glazing and the cassette. The cassette may be between the first glazing and the second glazing. The second glazing may be between the first glazing and the window shade. The window shade may be between the first glazing and the second glazing. One or more rails in the window shade pocket may receive at least one of the first bracket or the second bracket. One or more rails in the window shade pocket may receive at least one of the cassette or the holder.

### BRIEF DESCRIPTION OF THE DRAWINGS

The features and advantages of the present disclosure will become more apparent from the detailed description set forth below when taken in conjunction with the drawings, wherein like numerals represent like elements.

FIG. 1 is a version of the system with the cassette sitting lower in the first bracket, and the Z-block extending around the second bracket, in accordance with various embodiments.

FIG. 2 is a version of the system with the Z-block extending around the second bracket and the cassette, in accordance with various embodiments.

FIG. 3 is a version of the system with the second glazing adjacent to the first glazing and the cassette extending beyond the window pocket, along with the Z-block extending over the cassette and around the second bracket, in accordance with various embodiments.

FIG. 4 is a version of the system with the cassette interfacing with the top of the pocket, and the Z-block extending around the second bracket, in accordance with various embodiments.

FIG. 5 is a version of the system with the cassette sitting lower in the first bracket and holding a cellular shade, and the Z-block extending over the cassette and over the second bracket, in accordance with various embodiments.

FIG. 6 is a version of the system with the cassette interfacing with the top of the pocket, and the Z-block extending around the second bracket, in accordance with various embodiments.

FIG. 7 is a version of the system with the cassette interfacing with the top of the pocket, and the Z-block extending around the second bracket, in accordance with various embodiments.

FIG. 8 is a version of the system with the cassette interfacing with the top of the pocket, and the Z-block extending around the second bracket, in accordance with various embodiments.

FIG. 9 is a version of the system showing more details of the first bracket and second bracket, a holder and the Z-block extending around the second bracket, in accordance with various embodiments.

FIG. 10 is a version of the system showing an integrated first bracket and second bracket, along with a holder, in accordance with various embodiments.

FIG. 11 shows an exemplary Z-block, in accordance with various embodiments.

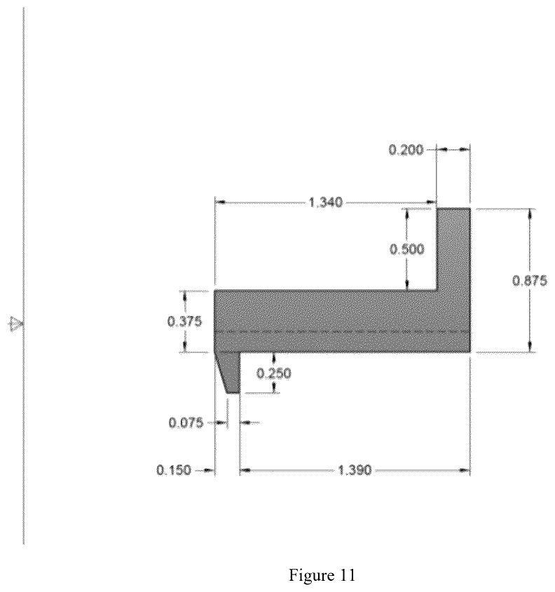

FIG. 12 shows an exemplary second bracket and an exemplary holder, in accordance with various embodiments.

FIG. 13 is a version of the system showing the first glazing, the first bracket, the cassette, window shade, second bracket, a holder, second glazing and the Z-block extending over the first bracket and over the second bracket, in accordance with various embodiments.

FIG. 14 shows exemplary cassettes for different types of window coverings, in accordance with various embodiments.

FIG. 15 shows exemplary facia and trim, in accordance with various embodiments.

FIG. 16 shows a wider version of an exemplary modular frame that holds the first bracket, the cassette, window shade, second bracket, a holder, second glazing and the Z-block, in accordance with various embodiments.

FIG. 17 shows a taller version of an exemplary modular frame that holds the first bracket, the cassette, window shade, second bracket, a holder, second glazing and the Z-block, in accordance with various embodiments.

### DETAILED DESCRIPTION

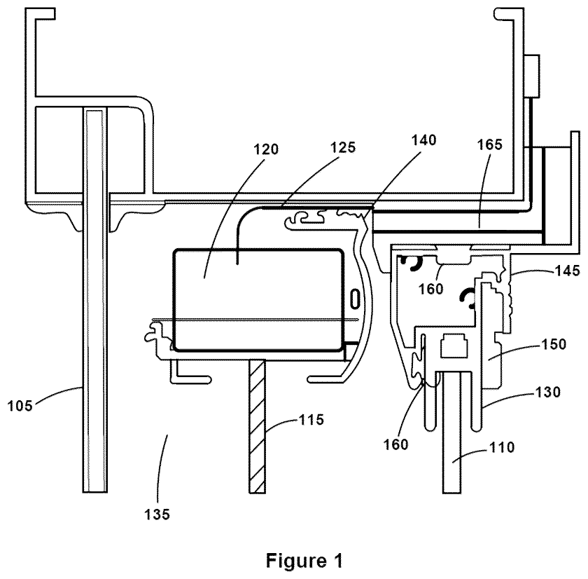

As shown in FIG. 1, an older building may have an original single pane window (first glazing 105) within a window pocket 135, wherein the window pocket 135 includes any type of opening in a building wall. The opening may be in the interior surface of the building and/or in the exterior surface of the building. The first glazing 105 may comprise one or more panes, but one or more second glazings 110 may still be helpful to provide more energy savings. Furthermore, the first glazing 105 may be comprised of older technology such that it may still be helpful to provide more energy savings. Older technology may include, for example, lower thermal performance, lower solar control, glass that allows more heat to penetrate through the glass, glass that shakes or breaks during wind storms or loud music, distorted glass, cracked glass, chipped glass, loss of tint, glass that is discolored, etc. Moreover, as used herein, the “original” window pane may be the window pane installed at the time the building was constructed, or may be a replacement window pane that still includes older technology such that one or more second glazings 110 may be helpful to provide more energy savings.

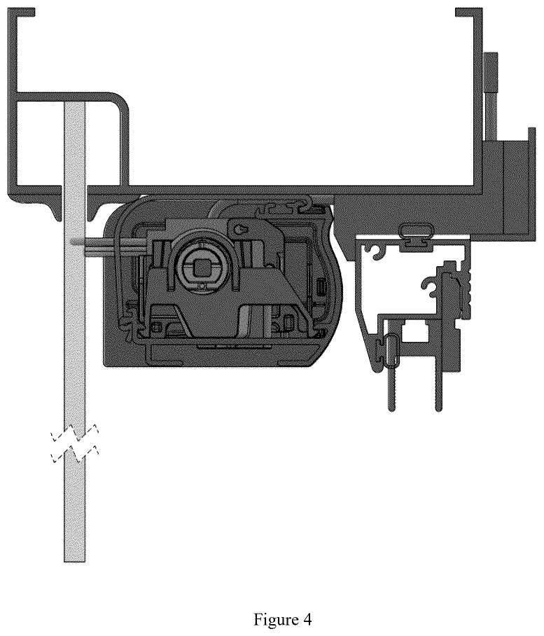

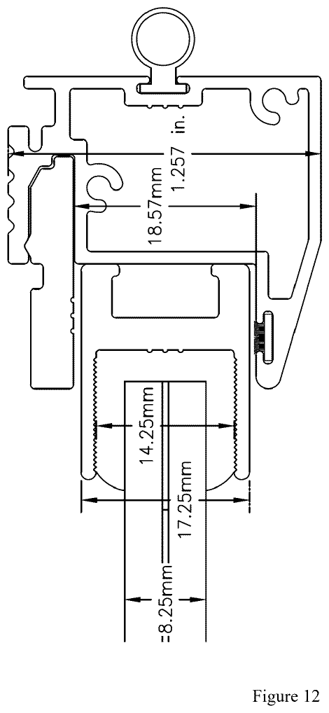

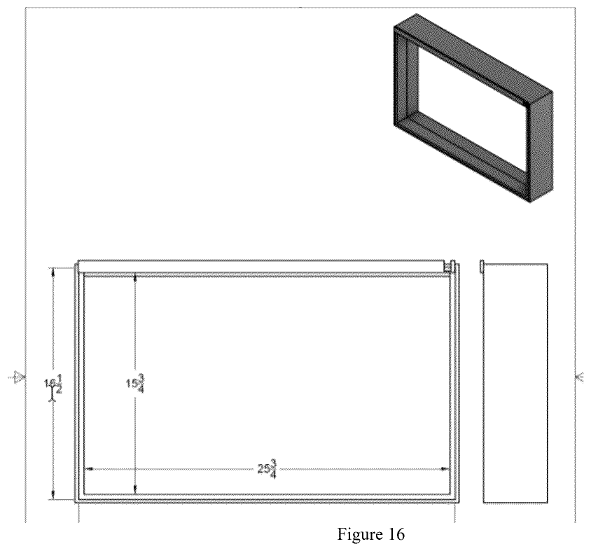

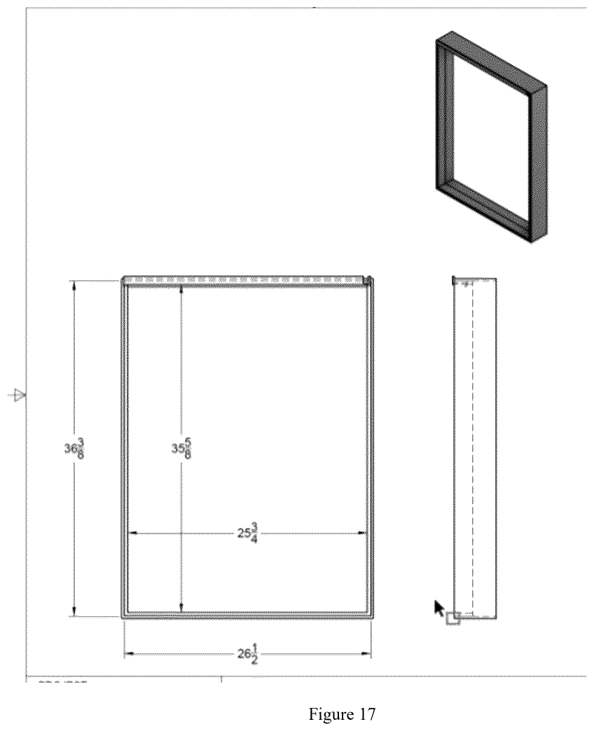

The first glazing 105 may be held at the back of the window pocket 135, wherein the back is closest to the outside of the building. The system may be a modular component that includes a frame (as shown in FIGS. 16 and 17) having a cassette 120 and a second glazing 110. Next to the first glazing 105, the system may include the cassette 120 having window shade gearing and/or a motor. Different types of cassettes with different types of window coverings are shown in FIG. 4. The window shade gearing and/or motor is configured to retract or extend the window shade 115 along the face of the first glazing 105. The system incorporates a second glazing 110 on one side or both sides of the first glazing 105. In various embodiments, the system incorporates a second glazing 110 next to the inner side of the first glazing 105 (i.e., the side facing the inside (and in the inside) of the structure). In various embodiments, the second glazing 110 may include one or more second glazings 110, as shown in FIG. 12. Each of the glazings may or may not include vacuum insulation in the space between the glazings (e.g., between first glazing and second glazing, between two second glazings, between two first glazings). The glazings may be added next to the inner side of the first glazing 105. The second glazing 110 may also employ low-e coated glass to help improve energy efficiency. The second glazing 110 may be any distance from the first glazing 105. In various embodiments, the first glazing 105 and the second glazing 110 may be configured at a distance that allows enough room for a window shade 115 to traverse between the two glazings.

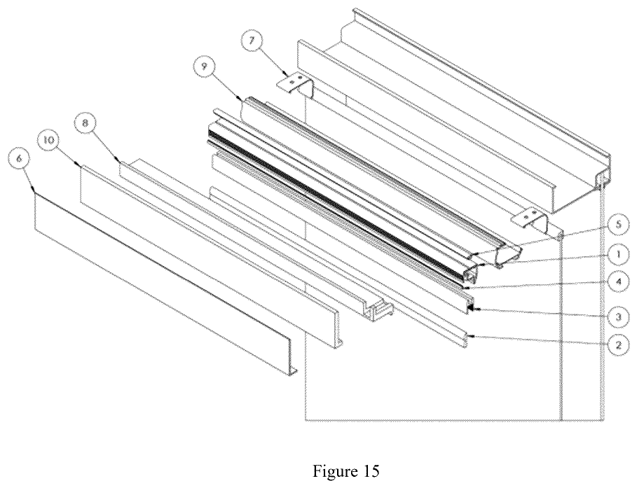

The system may provide significantly higher thermal performance and solar control, and most notably, multiple tiered performance options that allow the building owner to optimize the cost performance benefits for their specific situation. More particularly, the system includes a secondary glazing subsystem (SGS) with increasing performance levels using, for example, vacuum insulating glass (VIG) in place of a standard single pane low-e panel or IGU glazing, an insulating frame trim cap (as shown in FIG. 15) with optional custom color to help cover and insulate existing frames (which typically have no thermal break in older existing buildings) and an optional automated cellular shade subsystem located between the SGS panel and the existing window to enable dynamic solar control. The combined system provides very high performance in terms of both low U-factor and dynamic solar control from low to high solar heat gain coefficient (SHGC), at a fraction of the cost of full window or façade replacement. The SHGC is the fraction of solar radiation admitted through a window, either transmitted directly and/or absorbed, and subsequently released as heat inside a building.

Importantly, the modular system provides the flexibility to choose from one or more of these options and the tiered-performance system also provides the ability to customize the level of performance, cost, and details for a specific building. For example, based on the cost restrictions and performance goals for a specific project, a building owner or architect in a cooling-dominated or mixed climate may choose the insulating frame trim cap (as shown in FIG. 15) and shading system, but with a standard low-e panel to have lower incremental cost than VIG. Conversely, a building owner or architect in a heating-dominated climate may choose the insulating frame trim cap and VIG, but may not need the dynamic shading system in a particular situation. The owners may choose the trim cap, shading system, and VIG to maximize overall performance for all situations. As such, the system provides flexible options in cost and performance for the building owner, which may support successful marketing and commercialization.

The system may be quick to install, provide a smooth mounting surface, durable structural attachment, accessibility to maintain components between the first glazing and second glazing, and thermal separation from the existing window frame. In addition to reduced energy usage, this system provides significant non-energy benefits including increased thermal and solar/visual comfort while maintaining views and daylight for occupant health and well-being. Additionally, the lower U-factor and shading system increase building resilience, especially in multifamily housing, by allowing better control of the interior environment and temperature even in case of power outages (automated shading systems can be powered with a small PV cell and/or manual override). Condensation potential and thermal comfort are also greatly reduced by significantly increasing the interior surface temperature. The design and insulating frame trim cap increase the cold-point temperature on the interior frame from approximately 12 F up to 35 F when the exterior temperature is 0 F. Furthermore, the VIG panel and air tightness both provide superior sound attenuation to increase acoustic performance and enhance the interior environment.

In various embodiments, the first glazing 105 and the second glazing 110 may be configured at a distance to also provide enough room for cassette 120, first bracket 140, gearing, a chain, a lever, a wand and/or a motor, each of which may be used to extend or retract the window shade 115. The wand, chain and/or lever may extend or be accessible from the inside of the room, or an additional component (inside the room) may interface with the wand, chain and/or lever that is between the glazings. The gearing may be part of and/or within a cassette 120 that may attach to the top of the window pocket 135.

In various embodiments, the system may include separate components that are installed without a frame, wherein the components include one or more of the window shade 115, cassette 120, first bracket 140, holder 130, second bracket 145, gaskets 135, locking device 150, cabling 125 and/or Z-block 165. In various embodiments, the system may include separate components that are configured to be part of an integrated product with one or more of the window shade 115, cassette 120, first bracket 140, holder 130, second bracket 145, gaskets 135, locking device 150, cabling 125 and/or Z-block 165, all integrated into a frame (as shown in FIGS. 16 and 17). The integrated frame may be installed as a single unit to expedite installation. In various embodiments, the system may include one or more separate components that may be configured to be installed separately, or one or more separate components that are configured to be installed into the integrated frame system that contains the rest of the components. Additional components may be installed before or after the rest of the integrated system is installed. The frame, as shown in FIGS. 16 and 17, may be installed partially or fully inside the window pocket, or the frame may be installed partially or fully outside the window pocket. Any of the components and/or frame may be installed into the window pocket with any type of fasteners, adhesives and/or sealants such as, for example, screws, nails, clips, springs, caulking, glue, insulation, and/or the like.

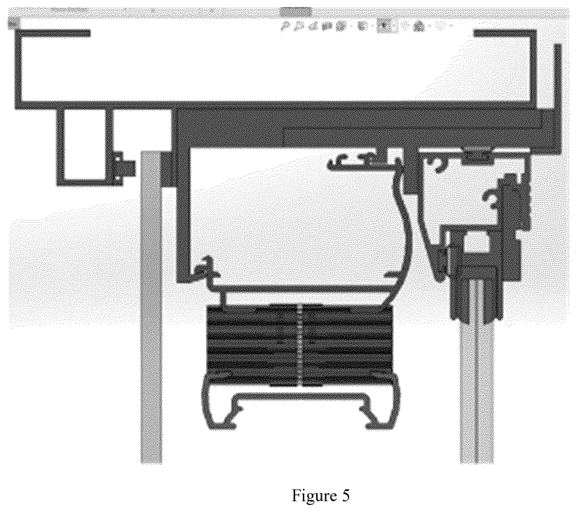

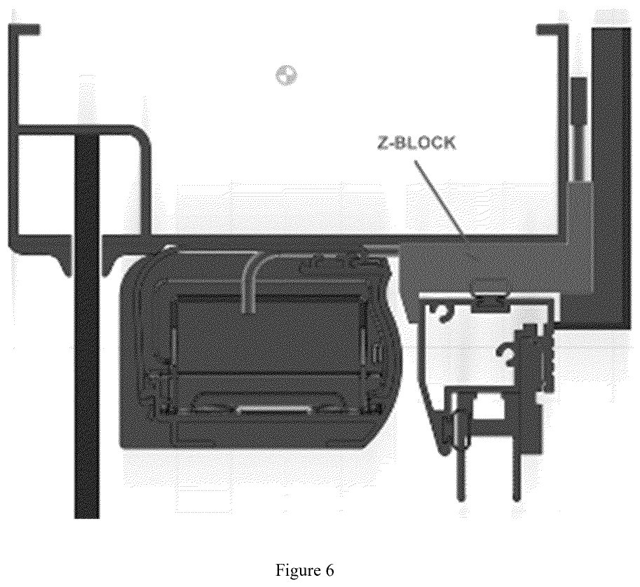

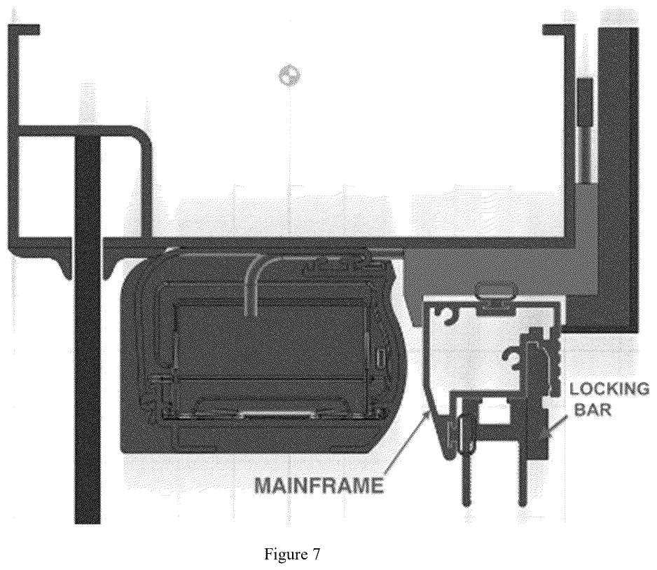

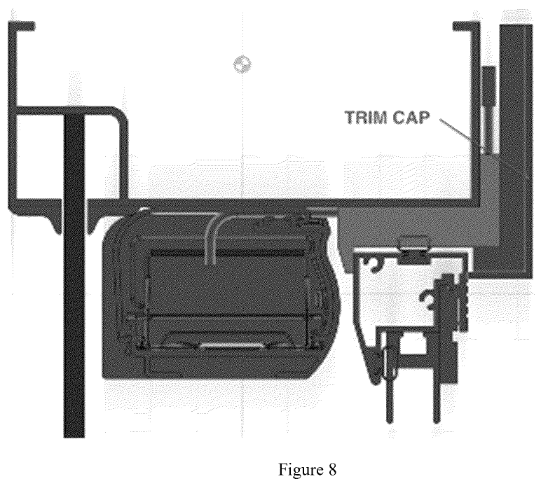

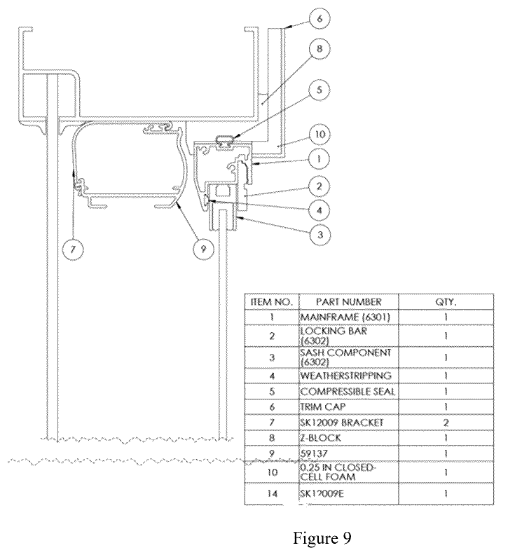

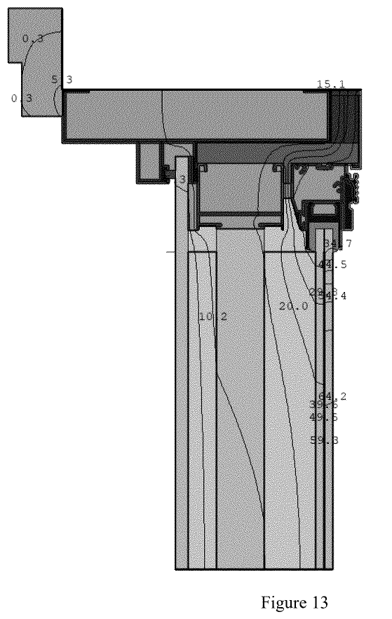

FIGS. 1-10 and 13 show different embodiments of the modular system that may include one or more of window shade 115, cassette 120, first bracket 140, holder 130, second bracket 145, gaskets 135, locking device 150, cabling 125 and Z-block 165. Cassette 120 and holder 130 may directly or indirectly attach to or interface with any part of the inside and/or outside of the window pocket 135. For example, cassette 120 and holder 130 may directly or indirectly attach to or interface with the inside frame at the top of the window pocket 135. A top of first bracket 140 may interface with the inside frame at the top of the window pocket 135 and a lower portion of first bracket 140 may interface with cassette 120. Any portion of first bracket 140 may interface with any portion of cassette 120 at one point of contact or at multiple points of contact.

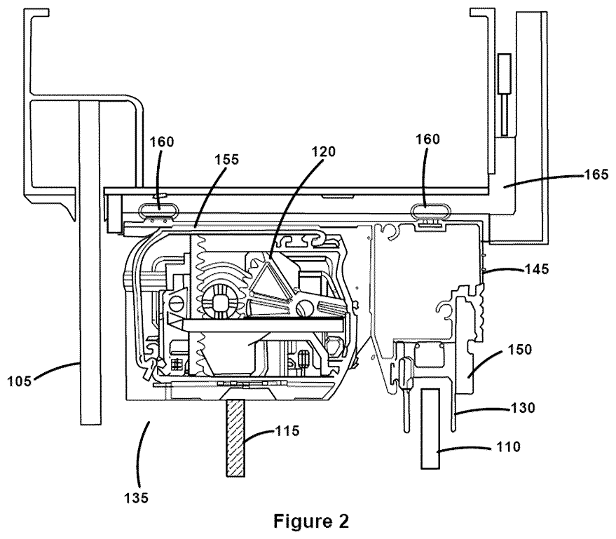

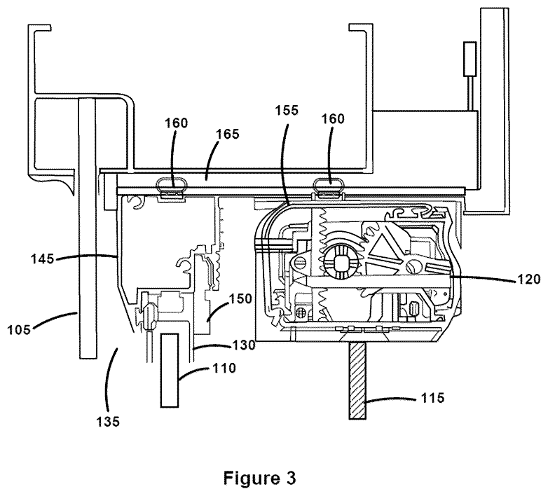

As shown in FIGS. 2 and 3, a spring clip 155 (e.g., steel) may help to support the cassette 120. The spring clip 155 may be inserted into and/or pressure fit around cassette 120. The spring clip 155 may also be affixed (e.g., riveted) to second bracket 145 (e.g., base channel) that extends over cassette 120 and also supports holder 130. The spring clip 155 may allow for easy removal of cassette 120 for servicing. The spring clip 155 may include an integrated flange that interfaces with the base channel (e.g., within a channel in the base channel). The base channel may also include channels for the glazings and the cassette 120 to help support the modularity of the assembly.

As mentioned, the top of the window pocket 135 may attach to the first bracket 140 that holds the cassette 120. With spring clip 155, the cassette and/or motor may be removable from the first bracket 140. The cassette 120 and/or motor may be removable from the first bracket 140, while the first bracket 140 is secured to the top of the pocket frame. The system may also include a common extrusion for the cassette 120 that may reduce the depth of the overall SGS and shade unit, as shown in the figure. The extrusion for the cassette 120 may be combined with the extrusion for the SGS that the SGS fits into. Reducing the depth may allow the system to be inserted into a wider portion of the windows market. For example, this configuration may remove about ⅜ inches from the overall depth.

A top of second bracket 145 may interface with the inside frame at the top of the window pocket 135. A lower portion of second bracket 145 may interface with holder 130. Any portion of second bracket 145 may interface with any portion of holder 130 at one point of contact or at multiple points of contact. In various embodiments, second bracket 145 and/or holder 130 may include one or more of a mainframe, a locking bar, a sash component, weatherstripping, and/or a compressible seal. The second bracket 145 may also include components that receive fasteners. For example, second bracket 145 may include C-shaped components that are configured to receive fasteners (e.g., screws) to connect the different sub-components (e.g., four sides) of second bracket 145.

In various embodiments, cassette 120 and/or holder 130 may be inserted into one or more rails on the bottom of first bracket 140 and/or second bracket 145. In various embodiments, cassette 120 and/or holder 130 may be inserted into one or more rails on the inside of the frame at the top of window pocket 135 (instead of being inserted into first bracket 140 and/or second bracket 145).

As shown in FIG. 3, certain window pockets 135 may be narrow, such that the cassette 120, second bracket 130 and second glazing 110 may not be able to all fit within the depth of the window pocket. To provide extra spacing, the cassette 120, first bracket 140 (or base channel), gearing, a chain, a lever, a wand and/or a motor may be located partially or fully outside of the window pocket 135. In various embodiments, cassette 120, first bracket 140 (or base channel), gearing, a chain, a lever, a wand and/or a motor may be located at the room edge of the window pocket 135. In other words, the first glazing 105 is directly next to the second glazing 110, then the cassette 120 (or other cassette components) is on the room side of the second glazing 110. In various embodiments, a portion of cassette 120 and/or first bracket 140 (or base channel) may interface with the inner frame of the top of window pocket 135, while the remaining portion of cassette 120 and/or first bracket 140 (or base channel) extends outside of window pocket 135 and into the inside room. In various embodiments, cassette 120 and/or first bracket 140 (or base channel) may interface with the vertical portion outside of the window pocket 135, such that the entire cassette 120 and/or first bracket 140 (or base channel) is outside of the window pocket 135.

In this configuration, the trapped solar heat may be between the second glazing 110 and the window shade 115, which may now be within the building (instead of between the glazings). As such, this configuration (or other configurations discussed herein) may also include a system for venting the trapped solar heat gain. For example, the Z-block 165 may include raceways to vent the trapped solar heat gain to the front of the window module, such that the trapped solar heat gain can be directed and/or vented to another area (e.g., to the plenum) and away from the occupied space in the hotter months.

In various embodiments, the window pocket 135 may include a duct to allow the heat to flow out of the pocket 135 or be pulled out of the pocket 135 by an air handling system. In various embodiments, the Z-block 165 may include holes, openings, channels or ducts to allow the heat to flow out of the pocket 135 or be pulled out of the pocket 135 by an air handling system. The system and/or ductwork may be configured as fixed, removable, a vertical slider or a horizontal slider. As such, the system may allow for egress or natural ventilation. Both the fixed and operable versions enable equitable access to improve building performance and reduce utility costs for occupants, especially in comparison to expensive glazing and window replacements. The vent may be electronically controlled, such that an HVAC and shade system can determine when to keep the solar heat gain to help offset heating needs in the occupied space. One or more of the duct and other components may be comprised of any material. In various embodiments, one or more components may be comprised of aluminum.

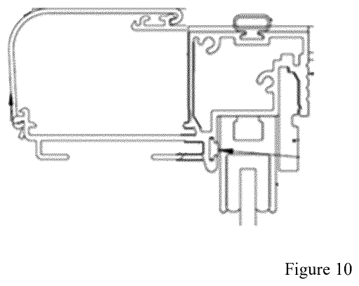

As shown in FIG. 10, the system may include a Z-shaped component (known as a Z-block 165). The Z-block 165 may be comprised of any material (e.g., nylon). The Z-block 165 may be comprised of one or more components that have a Z-like configuration. For example, the Z-like configuration may include any device that includes a component (e.g. horizontal) with a first protrusion in a first direction (upward in front of the pocket/window header) from a first end of the component (front return leg) and a second protrusion in a second direction from a second end of the component (back return leg). The Z-block 165 helps to keep the other components aligned. The back return leg may form a stop for the base channel (that extends from the second bracket 145 and over the cassette 120). The front leg helps to form a stop against the window header. One or more gaskets 160 may help to form a seal between the base channel and the Z-block 165. One or more gaskets 160 may be inserted between the window header and the Z-block 165. The Z-block 165 provides a quick-to-install smooth mounting surface, a durable structural attachment, helps align various components, a means for sealing the other components and a thermal separation between the SGS and existing window frame. A portion of the Z-block 165 may include an attachment strip. In various embodiments, the Z-block 165 extends outside of the window pocket 135 and partially up a portion of the wall, across the upper inner portion of the window pocket 135 and down around the holder 130. In various embodiments, the Z-block 165 extends outside of the window pocket 135 and partially up a portion of the wall, across the upper inner portion of the window pocket 135 and down around the first bracket 140 and/or cassette 120.

With respect to mounting and brackets, the system may include various embodiments. In a first example, the shade may mount independently to the window header via two brackets. The second glazing 110 may mount to the Z-block 165. The Z-block 165 may mount independently to the window header. In a second example, the shade mounts independently to a common Z-block 165 via two brackets, the second glazing 110 mounts to the common Z-block 165 and the Z-block 165 attaches directly to the window header. In a third example, the common Z-block 165 includes features that clip into the shade, the second glazing 110 mounts to the common Z-block 165 and the common Z-block 165 attaches directly to the window header. As used herein, a common Z-block 165 is the Z-block 165 that extends over both the cassette 120 and the second glazing 110. The Z-block 165 can attach directly to the cassette 120. The Z-block 165 may house a clip for the cassette to snap directly into.

First bracket 140 and second bracket 145 may be configured with a certain height such that the bottom of holder 130 (and/or top of second glazing 110) is at a similar height as the bottom of cassette 120 (and/or the top of window shade 115). In various embodiments, the Z-block 165 may provide extra spacing down from the top of the window pocket 135. For example, due to the larger size of the cassette 120 and the larger first bracket 140, the bottom of cassette 120 may extend farther down from the top of window pocket 135. The Z-block 165 may provide spacing between the top of the window pocket 135 and holder 130, such that the bottom of holder 130 (and/or top of second glazing 110) is at a similar distance (from the top of window pocket 135) as the bottom of cassette 120 (and/or the top of window shade 115). In various embodiments, the Z-block 165 may provide spacing for cassette 120 and/or first bracket 140.

More particularly, and as set forth in more detail in the FIGS. 1-3, the electrical cable 125 from the motor may exit the system via a channel. For example, the electrical cable 125 from the motor may exit in a channel formed between two components in the support header above the first bracket 140 and second bracket 145. The channel may be incorporated into the first bracket 140 and/or the channel may be at least partially in a space between the brackets and the window shade pocket 135. The channel may be part of the Z-block 165. The Z-block 165 may provides a pathway for any recharging cable used by the motor to be conveniently routed out and tucked just behind the front fascia, such that the cable is hidden but also available for a charging connection. In various embodiments, a photovoltaic recharging system may be attached to cassette 120, so no external connection is required for the shade motor batteries.

A trim cap may cover the installation. The trim cap may be Saint-Gobain Norseal V740 0.250 in. thick closed-cell foam tape which occupies the space between the aluminum (fascia) trim cap and the existing window jamb. The trim cap creates a finished appearance but also serves to insulate the existing exposed metal jamb, reducing heat transfer and potential condensation. The trim cap can be provided in custom colors to match the building owner's desired aesthetic.

The system may include a rechargeable battery to power the motor for the shade. The system may mount a solar cell in the window to recharge the battery. In this way, the battery does not need to be replaced or is replaced much less often. The system may recharge the battery without a facility manager's coordination, and the system does not need to include the wiring to the battery (which enhances the cosmetics). The system may also include an area to house the rechargeable batteries. The interstitial chamber gets too cold for Lithium Ion especially if VIG glass is used as the second glazing 110. Nickel-metal hydride may work, but still the environment in the chamber varies widely. The system may be configured to support a current or future battery technology. For example, the system may include a non-battery solution for rechargeable energy storage (e.g., a super capacitive rechargeable power source). The Z-block 165 may include a vent to the room environment, while still sealing the interstitial chamber, to help maintain the conditions in the space for the battery. This may also help reduce motor noise. In various embodiments, the Z-block 165 may be configured such that a cavity in front of the window header houses a battery that is hidden by the trim cap. Such a battery may be serviceable after installation from the room, without removing the SGS.

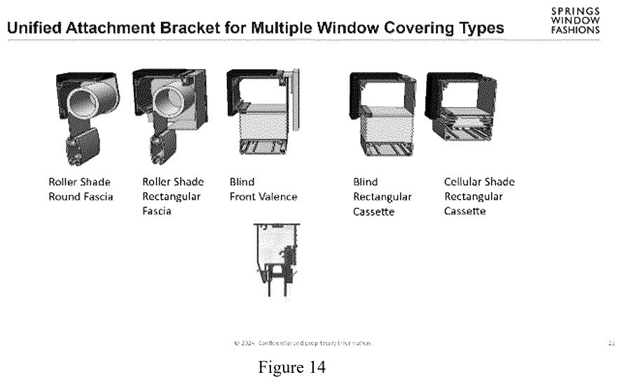

As shown in FIG. 14, cassette 120 may include one or more window shades 115, wherein window shades 115 may comprise one or more of any type of window shades such as a cellular shade, tilt blind, vertical blinds, horizontal blinds, louver shade, roller shade and/or the like. In various embodiments, the system may include a cellular shade or louver shade because such shades require less space when retracting such shades. A roller shade may require more space in certain areas around the pocket to accommodate the roll of shade material, when the window shade is rolled up. Moreover, a cellular shade may use a motor that is less expensive than a roller shade motor.

In various embodiments, the system may include window shade 115, the window shade gearing, the window shade motor, the one or more second glazings 110, one or more gaskets 160, first bracket 140, second bracket 145, one or more channels within one or more brackets (for cabling) and/or one or more frame components. All or any subset of the components may be permanently and/or removably incorporated into a single integrated unit or multiple sub-units. Any of these components within the integrated unit may be selected based on any budgetary or energy conservation needs or goals. Any of these components within the integrated unit may be removed or fixed if a component is broken. Any of these components within the integrated unit may be replaced with an upgraded component or upgraded technology in the future. For example, the window shade 115 may be replaced with photovoltaic shading, along with any needed adjustments or upgrades to the gearing, motor, brackets and/or channels (to accommodate the electrical lines).

Such integrated unit may be incorporated into the window pocket 135 (behind the first glazing 105) to create a multiple pane arrangement. The integrated unit may be constructed as a portion of a frame or a complete frame that is optimized for easy installation. The frame that includes the components may be installed as an integral unit into the window pocket. The frame may pressure fit into the window pocket. The frame may be any shape and comprises any number of sub-components. For example, the frame may be a square, rectangle, circle, oval or polygon. The integrated unit may include one or more magnets, such that the integrated unit may removably couple to the existing metal window frame that may be within the window pocket and/or outside the window pocket. The integrated unit may be secured inside the window pocket by tape, glue, Velcro, nails, screws or any other fastener. The integrated unit may be secured inside the window pocket by sliding the integrated unit into one or more channels around at least a portion of the window pocket.

This design minimizes visual impact with a narrow sightline, while also allowing building owner customization of the frame color and optional automated shade type/color/fabric to meet aesthetic requirements, including in historic buildings. The top portion (containing the first bracket 140 and top of the second bracket 145) of the integrated unit may only obstruct the view of a few inches of the top of the first glazing 105. The bottom portion (containing the bottom of the second bracket 145) of the integrated unit may only obstruct the view of a few inches of the bottom of the first glazing 105.

The one or more second glazings 110 may be mounted within a second bracket 145. For example, one or more sub-components of second bracket 145 may receive one or more sides of second glazing 110. In various embodiments, for sub-components of second bracket 145 (e.g., the four sides of the rectangle) may receive the four sides of second glazing 110. The second bracket 145 may include a holder 130 (glazing boot) that holds at least a portion of the second glazing 110. Holder 130 may be U-shaped and/or be elastomeric. Holder 130 may be within a sash component. The bottom and/or sides of the second glazing 110 may also be supported by additional brackets or mounts. In various embodiments, the holder 130 holds at least a portion of all four sides of the second glazing. In various embodiments, the second bracket 145 may include a locking bar (e.g., shim) 150 that secures the holder 130 in the second bracket 145. Upon rotation or removal of the locking bar 150, the second glazing 110 and/or the second bracket 145 may be removed from the integrated system for servicing or replacement. As shown in FIG. 3, the system may provide sufficient space between the locking bar 150 and cassette 120 to allow the locking bar 150 to rotate or be removed. However, to save space in narrow window pockets, the cassette 120 may need to be very close to the holder 130, so the cassette 120 may be removed to allow the locking bar 150 to rotate or be removed. The removal of the second glazing 110 and/or the second bracket 145 may allow access to the area between the first glazing 105 and the second glazing 110. The removal of the second glazing 110 and/or the second bracket 145 may allow access to the area between the second glazing 110 and the window shade 115.

The second bracket 145 may extend outside of the window pocket 135 and partially up a portion of the vertical wall to provide extra support for the second bracket 145. The portion on the vertical wall may interface with the trim cap assembly. The trim cap may include a custom color to help cover and insulate existing frames (the existing frame may not have a thermal break in older buildings). If that portion of the wall has a metal plate, then the second bracket may include a magnetic surface to adhere to that portion of the wall. A portion above first bracket 140 and/or second bracket 145 may include an attachment strip. The attachment strip may include an extruded polymer attachment strip (Nylon). The attachment strip may include pressure-sensitive adhesive closed cell foam tape, which thermally isolates the existing frame as well as provides an air-tight seal.

The brackets, Z-block 165 and/or the integrated system may be partially or fully sealed to minimize any openings and minimize the heated air from exiting the window shade pocket 135. The system may incorporate a gasket 160, bubble seal (e.g., compressible), tape (e.g., closed cell foam insulating tape) or weather stripping on or around any component of the system or over any holes in the system, to help seal the system. In various embodiments, the components may include a mainframe, a sash component and a locking bar. The locking bar may hold the sash in place. Weatherstripping may be used to create a seal between the sash and frame. The sash may be removable in the field to facilitate any maintenance access. An elastomeric compressible seal may be used as one of three seal points between the mainframe and Z-block 165. The Z-block 165 may be constructed from stock PVC extrusions, though the commercial application may be an extruded PVC material. The geometry of the Z-block 165 is designed to quickly and consistently register the location of the mainframe for simplified interior recessed mounting, thereby simplifying installation. The Z-block 165 may also provide seal points between the mainframe to prevent interior air from entering the interspace between the SGS and prime window. The Z-block 165 may be directly screw attached to the existing prime window jam and is located on all four sides. The main frame may attach through the Z-block 165 into the existing window jamb through pre-drilled installation holes located on the vertical sides of the mainframe.

In various embodiments, the system may determine the solar heat gain between the window shade 115 and the window through the use of a temperature sensor placed within or near the area between the window covering and the window. For example, the system may include a temperature sensor on the window shade motor, wherein the motor is mounted in the area between the window shade 115 and the window in the pocket 135 to detect the increase of heat in this area associated with solar heat gain. The solar heat gain may also be forecasted or anticipated by a solar tracking controller for the shade system due to the location of the motor in the building and in relation to the sun's position in the sky. The system may use the temperature of the window pocket 135 for other purposes such as optimizing window shade 115 position based on the pocket 135 temperature during key times of the day and/or returning to automation mode from an override condition based on the pocket 135 temperature. For example, an occupant may have overridden the automation mode to raise the shade 115 and allow the room to get hotter than normal. However, the occupant may have subsequently left the room. As such, if the pocket 135 temperature gets too hot, the system may go back into automation mode to control the shade 115 and reduce the heat gain.

With respect to the shade assembly, the performance of the shade 115 assembly may be impacted by the assembly conditions. Such assembly conditions may include, for example, without side channels as a standard condition and with side channels as an enhanced condition for containing leakage of energy around the fabric band. In these situations, the pocket 135 often needs to be properly treated with light blocking surfaces, finishes and/or textures that prevent the reflection of light up and over a window covering. These features can often be applied on the room side of the path required to support good flow of heat gain into the ventilated or ducted connection to the pocket 135.

With respect to any of the glazings, consideration should be given to metal framing, thermally broken, double glazed (e.g., 6 mm clear glass, 12.5 mm air gap or 6 mm clear glass, 12.5 mm air gap, low-e coating on surface #2), SolarBan 60 (the most representative of high performance commercial building infrastructure (70% VLT, 0.39 SHGC)), SolarBan 70 (formerly SolarBan 70XL and the most common glass used in new commercial building infrastructure (64% VLT, 0.27 SHGC)) and punched window compared to curtainwall. The glazing characteristics may help determine how energy will travel through the curtainwall system, and ultimately determine the amount of heat gain that may need to be handled by the system. This may dictate design impacts like the selection of the components of the system, size and frequency of venting, the frequency of ductwork, etc. A low-e coating on the glass especially impacts the ability for infrared (IR) energy to penetrate the glazing coming into the room environment, and also helps to retain radiant heat from escaping the building envelope once inside. In various embodiments, the glazing may comprise a Luxwall enthermal 8 mm vacuum insulating glass assembly. The glazing may include LuxWall Enthermal 10 mm vacuum insulated glazing. The outboard lite may be a 5 mm Cardinal 366 low-e, the inboard lite may be 5 mm clear and both lites may be fully tempered. Other VIG glass thicknesses, such as 8 mm nominal, may be used. The VIG may optionally be substituted with a monolithic low-e glazing layer using a durable low-e coating such as Guardian IS20 or Pilkington Energy Advantage, so the building owner may optimize desired cost and performance.

With respect to fabric, consideration should be given to the type of fabric or slats being used on the window covering dependent on the type of window covering chosen. For example, the density of the fabric (e.g., solar/perforated fabric or blackout fabric), the color of the fabric (e.g., dark materials tend to absorb a larger portion of the incident energy than lighter colors) and the material used in the fabric. For example, metal-based fabrics or louvers are better at reflecting more of the incident energy than non-metallic, while cellular shades with multiple pockets within its depth are better at insulating. For example, Mermet E-Screen which may be 1% openness factor, charcoal/charcoal or 1% openness factor, charcoal/charcoal with KOOLBLACK. The fabric may also include MechoShade 115 EuroTwill 6000 (3%) and 6200 series (1%) modelled with BSDF.

In various embodiments, the system may also optimize shade 115 positioning during a utility demand event while also presenting an operation outside of the demand event. For example, when solar heat gain is entering through a window and into a room, the system may adjust certain motorized window shades 115 (on windows facing the sun) that will block the solar heat from entering into a room. In this case, window shades 115 may be positioned to block solar heat gain where the extra heat is not desirable for the occupant. For example, such undesirable heat gain may occur more often in warm climates, seasonal temperate zones, summertime, etc. However, such solar heat gain may be desirable to help offset heating energy in the Winter time in seasonal temperate zones. Furthermore, heat gain may not be desirable in one area of the building when the sun is on that facade, but may be desirable in other areas of the building which are not exposed to the sun at that time, due to solar orientation or shadowing by urban or natural landscape. The system may receive feedback on the external temperature to help determine the optimal shade 115 position or other adjustments in the building systems. The system may also obtain data about occupancy to help a solar tracking system (e.g., may include real-time radiometer readings) engage control strategies for comfort (e.g., solar penetration, glare) when spaces are occupied. The comfort may be based on space utilization and climate zone-major metro location (e.g., open plan, office, conference rooms, cafeteria, and public space usage). The system may include strategies for energy conservation/carbon footprint reduction when spaces are unoccupied. The energy may be based on space utilization and climate zone. For example, in major metro commercial building locations, the energy savings may be based on open plan, office, conference rooms, cafeteria, and public space usage. Work schedules for week day, weekend and holiday may serve to identify when people are in the building. Such information about when people are in the buildings may be used to ensure that automation routines manage for energy savings and comfort, and not just energy savings. In residential spaces, occupancy status is also important, so the system may connect with home automation systems and/or security systems to understand different home control modes like “home”, “away”, “vacation”, etc. The automation may also use a scheduler that considers weekday, weekend, seasonal and/or space utilization strategies. The impact of the various automation strategies may include, for example, solar heat gain control, solar tracking, HVAC operating mode (heating or cooling), outside temperature, pocket 135 temperature, occupancy, peak vs non-peak energy hour automation and utility demand response programs for peak periods of the day, the scheduler, weekday vs weekend settings and/or seasonal.

A testing control algorithm may be used with the system. The shade system provides for automation to be used to optimize the energy performance of the glazing and thereby the building. By supporting BACnet within the automation controller, the shades may interface with the BMS system to help harmonize operation with the rest of the building systems. The flexibility of the system allows aspects of the following key control strategies to be included, customized to the specific building project. With an astronomical scheduler, customizable work schedules are available for weekday, weekend and holiday to serve as the baseline approach to controlling the shades based on occupancy. If it varies by areas of the building, the schedules may need to be broken down into schedules for each zone of control which should be oriented to facades of the building. Daylight savings time will auto adjust. Shade positioning can also be customized within the scheduler on zone basis, or the system can permit the shades to automate based on other inputs. The astronomic scheduler may know the solar angles relative to each zone's solar orientation. Therefore, the scheduler may be capable of automating shade placement based on the incident solar angle and its associated solar heat gain, as well as knowing when sunrise/sunset takes place.

As a general rule, outside of work hours, the shades may be positioned to optimize the energy performance of the zone/building (generally closed, unless capturing beneficial solar heat gain on southern exposures during heating period). During work hours, the shades may be positioned for energy performance, while ensuring occupant comfort and maximizing opportunities for daylight exposure and view.

Using demand response, if the building is setup to subscribe to peak demand programs through the utility, then a peak demand schedule can be configured to optimize the shade positioning during these times. Occupancy may be a refinement to the work schedule, wherein the automation system can optimize for energy management, especially when various zones are unoccupied during a work day. Occupancy may be provided by the BMS integration. The HVAC zone status may be available through the BMS, so the status of the HVAC in terms of heating and cooling modes can drive the shade automation system to either accept solar heat gain (open the shades) or reject solar heat gain (close the shades) when direct solar is incident on a zone's window. The temperature differential may be available through the BMS, so cellular shades can be deployed to help add or reduce insulation by closing or opening respectively to help support work being done by the HVAC mode of operation.

The sky type may be available through the use of Internet Weather or the use of a weather station, so the astronomic scheduler will know the condition of the sky and will qualify it into at least clear, cloudy and night sky conditions. Under clear sky, the system may be capable of harnessing when direct solar is incident on windows within the zone, and either reject or accept the direct solar based on the HVAC zone status. Under cloudy sky, there is no solar heat gain, so shades may only be deployed based on opportunities to help insulate the building or when occupied and visual comfort mitigation is needed from glare. If visual comfort mitigation is desired, then the shades could be deployed to 50% where insulation is not required. Under night sky, there is no solar heat gain and the shades may only be deployed based on opportunities to help insulate the building.

Solar heat gain may be the primary factor driving energy performance. Solar heat gain is associated with direct solar being incident on the facade, and can be managed through the use of both proactive and reactive control strategies. An astronomic scheduler with a weather station including solar radiometers (pyranometers) mounted on the building help to determine the real time solar load on the building and for each shade control zone of the building. By analyzing the radiometers and comparing to the ASHRAE clear sky threshold, the sky can be characterized as clear, cloudy or bright overcast.

A proposed test control scheme expects occupancy follows the planned work schedule. Regional historical weather data may be used for sky type and temperature data. When solar heat gain is on, the shade is positioned to a zone that either blocks or accepts solar heat gain based respectively on the HVAC zone status of cooling or heating. When the temperature differential shows the outside temperature is below the internal and the HVAC Zone Status is heating, or the outside temperature is above the internal and the HVAC Zone Status is cooling, then the shades may be fully deployed. Otherwise, the shades may be up or positioned due to other requirements.

The system may presume a standard Work Schedule for the weekday (i.e., 8 to 5). During these hours, the building may be managing for energy conservation, while ensuring occupant visual comfort. Ensuring visual comfort includes protecting for glare. Therefore, the system presumes managing for visual comfort and daylight/view exposure is limited to bright overcast conditions. Depending on the weather data, this may or may not be able to be easily identified.

In an exemplary embodiment, the shading system may consist of the shade and headrail attached to a head frame by a bracket. A wireless motor (e.g., Somfy motor) may be contained within the headrail, with wiring routed to the interior through a gap on one end of the Z-block 165, and covered by the trim cap and foam tape to maintain the air seal. The shade may be a Springs motorized lift cellular shade using 9/16″ Discover single cell insulating cellular shade with a reflective interior coating. The shade may include a 1″ aluminum motorized tilt-blinds in various colors which support a narrower depth.

The shade may be powered and operated from an interior wired low voltage power supply to minimize wiring costs and cosmetics. The system may avoid battery powered motorization in order to avoid complications with managing battery charge and/or replacement within the interstitial space. In various embodiments, the panel may be designed to provide access should maintenance be performed on the motorized shade or cleaning of the external window. Another embodiment may take advantage of a solar panel within the interstitial space and an appropriately rated battery technology mounted either inside or outside the space to eliminate the need for interior wiring. From a control standpoint, cellular shades offer up/down control. Tilt blinds can offer tilt-only control and therefore may be supported with wireless keypads for manual control, or fully automated with a wireless automated control system with available access to integrate into a building management system.

The combined, installed structure may have a depth of 3.61 inches. Some installations may have less depth between the existing glazing and interior most point on the prime window jamb. In that situation, the depth may be reduced by modification to the geometry of the shade and frame, or selection of an alternative shade such as a motorized 1″ aluminum tilt-blind. In various embodiments, the system may incorporate the glazing and shade efficiently into the interspace, simplify installation with a modified Z-component, and define strategies for routine maintenance on the installed structure. The system may use thermal modelling to identify the contribution of specific elements of the design to the overall performance to improve efficiencies. In various embodiments, the system may extend the Z-component to isolate and bring the shade headrail and motor into the same thermal zone as the Mainframe (bringing it from the ‘cold side’ more to the ‘warm side’), and/or include limits on the control system that temporarily placed the shading system into a static position during cold events (ideally closed to also take advantage of the insulating performance benefit during these cold events).

The durability of the system may be a function of the durability of the underlying components. A mechanically fastened rigid frame design, unlike other products with less structural nonrigid framing materials, provides superior durability and stability, particularly with the added weight in larger sizes and vacuum glazing. Additionally, the design of the framing system allows access for maintenance, cleaning, or replacement of any components as needed.

The system provides operational energy and carbon savings by significantly reducing heat transfer as measured by the U-factor of the overall system through the highly insulating VIG, insulating cellular shade, thermally isolated frame system, and insulating frame trim cap. The design considers the thermal continuity and alignment of these features to overcome any thermal bridging through both the SGS and existing frame components. The shading system contributes dynamic solar control to maximize solar heat gain when beneficial (during heating periods) and minimize solar heat gain when detrimental (during cooling periods) as well as support occupant comfort by minimizing glare, and can be fully automated to optimize the control schedule. Automation can take into account occupancy either through a customized schedule for workday/weekend/holiday and/or pull in occupancy data from the BMS system to determine if the system is in a pure energy conservation mode or optimizing for comfort as well because people are present in the space. Through the BMS, the automation schema can be further enhanced if HVAC operational mode data (heating/cooling) and external/internal temperature data can be provided. In order to optimize solar heat gain control, the scheduler may possess solar angle tracking capabilities for the geodesic location of the building. Internet Weather or a weather station on the building can help provide data on the sky condition to further refine operation of the shades. In order to manage visual comfort for the occupant, a local glare sensor may be used within the office which pulls the shades down to at least 50% when energy management requirements otherwise have the shades up during occupancy.

In addition to thermal improvements in U-factor, the complete assembly also has multiple air leakage seal points to provide maximum air tightness, which is important in interior SGS systems to avoid interstitial moisture condensation. This system provides seals at the trim cap, the interface to the Z-block 165 mounting piece, the compressible seal between the SGS glazing frame and Z-block 165 mounting piece, and between the Z-block 165 mounting piece and the existing frame.

While shown as a fixed system, a modified version of this system can include an operable vertical or horizontal slider. This allows matching of the underlying product type for egress and/or natural ventilation purposes in all building types from offices to institutional buildings to low income multifamily housing, as well as matching profiles in historic buildings. Both the fixed and operable versions, as well as the flexibility to select options to be included in the system enable equitable access to improve building performance and reduce utility costs for occupants, especially in comparison to expensive glazing and window replacement which may only be available to higher lease rate/higher income locations.

The system may include solar tracking systems such as the features and functions in, for example, U.S. Ser. No. 14/692,868 which is a continuation of PCT Application No. PCT/US2013/066316 filed on Oct. 23, 2013 and entitled “Automated Shade Control System Utilizing Brightness Modeling”. PCT Application No. PCT/US2013/066316 is a continuation of U.S. Ser. No. 13/671,018 filed on Nov. 7, 2012, now U.S. Pat. No. 8,890,456 entitled “Automated Shade Control System Utilizing Brightness Modeling”. U.S. Ser. No. 13/671,018 is a continuation-in-part of U.S. Ser. No. 13/556,388 filed on Jul. 24, 2012, now U.S. Pat. No. 8,432,117 entitled “Automated Shade Control System”. U.S. Ser. No. 13/556,388 is a continuation of U.S. Ser. No. 13/343,912 filed on Jan. 5, 2012, now U.S. Pat. No. 8,248,014 entitled “Automated Shade Control System”. U.S. Ser. No. 14/692,868 is also a continuation-in-part of U.S. Ser. No. 14/461,619 filed on Aug. 18, 2014, now U.S. Pat. No. 9,360,731 entitled “Systems and Methods for Automated Control of Electrochromic Glass.” U.S. Ser. No. 14/461,619 is a continuation of U.S. Ser. No. 13/656,401 filed on Oct. 19, 2012, now U.S. Pat. No. 8,836,263 entitled “Automated Shade Control in Connection With Electrochromic Glass”. U.S. Ser. No. 13/656,401 is a continuation-in-part of U.S. Ser. No. 13/359,575 filed on Jan. 27, 2012, now U.S. Pat. No. 8,723,467 entitled “Automated Shade Control in Connection with Electrochromic Glass.” U.S. Ser. No. 13/359,575 is a continuation-in-part of U.S. Ser. No. 13/343,912 filed on Jan. 5, 2012, now U.S. Pat. No. 8,248,014 entitled “Automated Shade Control System”. U.S. Ser. No. 13/343,912 is a continuation of U.S. Ser. No. 12/475,312 filed on May 29, 2009, now U.S. Pat. No. 8,120,292 entitled “Automated Shade Control Reflectance Module”. U.S. Ser. No. 12/475,312 is a continuation-in-part of U.S. Ser. No. 12/421,410 filed on Apr. 9, 2009, now U.S. Pat. No. 8,125,172 entitled “Automated Shade Control Method and System”. U.S. Ser. No. 12/421,410 is a continuation-in-part of U.S. Ser. No. 12/197,863 filed on Aug. 25, 2008, now U.S. Pat. No. 7,977,904 entitled “Automated Shade Control Method and System.” U.S. Ser. No. 12/197,863 is a continuation-in-part of U.S. Ser. No. 11/162,377 filed on Sep. 8, 2005, now U.S. Pat. No. 7,417,397 entitled “Automated Shade Control Method and System.” U.S. Ser. No. 11/162,377 is a continuation-in-part of U.S. Ser. No. 10/906,817 filed on Mar. 8, 2005 and entitled “Automated Shade Control Method and System.” U.S. Ser. No. 10/906,817 is a non-provisional of U.S. Provisional No. 60/521,497 filed on May 6, 2004 and entitled “Automated Shade Control Method and System.” The entire contents of all of the foregoing applications are hereby incorporated by reference for all purposes.

In various embodiments, the system may include a sky camera system that may provide sky forecasting. Any of the sky forecasting operations may be conducted or enhanced by artificial intelligence (AI) or machine learning. AI may refer generally to the study of agents (e.g., machines, computer-based systems, etc.) that perceive the world around them, form plans, and make decisions to achieve their goals. Foundations of AI may include mathematics, logic, philosophy, probability, linguistics, neuroscience, and decision theory. Many fields fall under the umbrella of AI, such as computer vision, robotics, machine learning, and natural language processing.

Sky forecasting may contribute to optimizing the use of the solar heat gain or the settings for other building systems (e.g., lighting, electrochromic windows and HVAC) based on existing conditions and future conditions. Sky forecasting may also contribute to identifying the optimal energy resource such as the availability of using passive energy options based on the availability of optimal environmental conditions (e.g., sky transparency, sky condition, wind speed, etc.) for buildings equipped with options onsite, remote or via utility to employ solar, wind, coal, nuclear, etc. Sky forecasting may work in tandem with such options to validate the opportunity and quality of charging and to identify when the energy source will be capable of offsetting internal demand and to what extent. The sky camera system may incorporate any of the feature or functions set forth in U.S. Ser. No. 16/849,834, which is hereby incorporated by reference in its entirety for all purposes. The '834 application is a continuation-in-part of U.S. Ser. No. 16/240,479 filed on Jan. 4, 2019 and entitled “Sky Camera System Utilizing Circadian Information For Intelligent Building Control.” U.S. Ser. No. 16/240,479 is a continuation-in-part of U.S. Ser. No. 15/906,674 filed on Feb. 27, 2018 and entitled “Sky Camera System for Intelligent Building Control”. U.S. Ser. No. 15/906,674 is a non-provisional of, and claims priority to, U.S. Provisional Patent Application Ser. No. 62/513,733 filed on Jun. 1, 2017 and entitled “Sky Camera System for Intelligent Building Control.” U.S. Ser. No. 15/906,674 is also a continuation-in-part of U.S. Ser. No. 14/692,868 filed on Apr. 22, 2015, now U.S. Pat. No. 9,938,765 entitled “Automated Shade Control System Interaction with Building Management System.” The entire contents of all of the foregoing applications are hereby incorporated by reference for all purposes.

In various embodiments, the system may optimize automation routines to supplement energy storage for a building to help offset peak demand and extend the use of the power base. For example, the system may limit or restrict window shade 115 movements during peak energy demand times. The system may also move the window shades 115 prior to the need to move the window shades 115 to avoid the peak demand times that may exist an hour later. For example, the system may determine that solar heat gain may increase in an hour. However, the system may also determine that peak demand and higher energy costs may exist in an hour. Therefore, the system may, at the current time, adjust the window shades 115 on certain windows (i.e., windows that may experience the solar heat gain in an hour), such that the window shades 115 are in an optimum position to block or capture the solar heat gain that will arrive in an hour.

In various embodiments, the system may include battery operated motors that control the window shades 115. The system may optimize shade 115 movement to minimize power consumption in the battery powered motors. Sky cameras can play a role in minimizing shade 115 movement to reduce power needs based on determining existing sky conditions and future sky conditions. For example, the system may determine that a particular window is experiencing increasing solar radiation, so the system may instruct the battery powered motor to lower the window shade 115 over that window. However, a sky camera system may determine that that window may be impacted by clouds in the next 15 minutes, so the sky camera system may instruct the window management system to override the typical command to lower the window shade 115. Instead, the system may avoid activating the motor and avoid movement by keeping the window shade 115 up for a few extra minutes until the clouds appear.

In various embodiments, the system may include internally optimizing battery management or energy demand by optimizing lighting usage and minimizing window shade 115 adjustments, based on future sky conditions, weather data and/or limits based on a BTU threshold (on/off). Optimized integration of window shades 115 with lights and HVAC may help mitigate and/or shift load for energy reasons, while still optimizing for comfort. Such optimization is not limited to just the setting of shades 115 at a certain level, but rather, coordinating the movement of the window shades 115 (e.g., based on window orientations) with third party systems for lighting and HVAC settings. For example, the system may determine that the clouds may appear and a window may experience decreased solar load in the next 5 minutes. The system may work with the BMS to provide the forecasted sky condition and determine how much energy may be needed (or saved) to increase the HVAC settings, activate the motor to raise the window shades 115 and lower the lighting in a particular region of the building. Based on the optimal energy saving or minimal energy needs, the system may determine the optimal full or partial adjustment of the various systems.

In various embodiments, the system may include photovoltaic (PV) fabric. To harness energy, the PV fabric may be comprised of, for example, blackout shades welded to flexible PV cells. For cosmetic purposes, the system may include a dual shade such that the solar shade faces the outside and an aesthetically pleasing shade faces the inside. The dual shades may move at the same time, such that the occupant does not see the solar shade. The system may also include a fabric made with photovoltaic materials. The system may transfer power from the PV fabric to the motor inside the shade tube to provide energy to the shade system. The window shade 115 system may integrate with a power grid for the building, such that the power grid may store/consume the energy that the shades may harness. In particular, the system may bring the power off the motor and shade system to the building which is connected to the building power grid. The solar shade may harness energy from the sunlight and the window shade system may harness kinetic energy from the operation of the window shade roller, motor, etc. Kinetic energy may be captured by placing an unpowered motor assembly represented by a coil and magnet within the idle end of the shade 115. As the tube rotates, the armature rotates with respect to the coils thus generating electricity that can then be harnessed by a capacitor or battery system connected across the coils.

The detailed description of exemplary embodiments herein makes reference to the accompanying drawings, which show exemplary embodiments by way of illustration and its best mode, and not of limitation. While these exemplary embodiments are described in sufficient detail to enable those skilled in the art to practice the invention, it should be understood that other embodiments may be realized and that logical, chemical and mechanical changes may be made without departing from the spirit and scope of the invention. For example, the steps recited in any of the method or process descriptions may be executed in any order and are not necessarily limited to the order presented. Moreover, many of the functions or steps may be outsourced to or performed by one or more third parties. Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option. Additionally, any reference to without contact (or similar phrases) may also include reduced contact or minimal contact.

Systems and methods are provided. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

For simplicity and clarity of illustration, the drawing figures illustrate the general manner of construction, and descriptions and details of some features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable. As used herein, “electrical communication” or “electrical interconnection” may refer to any electrical, electromagnetic, radiofrequency and/or optical method whereby information may be conveyed. As used herein, “electronic communication” means communication of electronic signals with physical coupling (e.g., “electrical communication” or “electrically coupled”) or without physical coupling and via an electromagnetic field (e.g., “inductive communication” or “inductively coupled” or “inductive coupling”). As used herein, “logical communication” or “logical connection” may refer to any method by which information may be conveyed. Logical communication may facilitate the transmission of signals, whether analog or digital, between two or more components. Thus, “logical communication” may refer to any electrical, electromagnetic, radiofrequency and/or optical method whereby information may be conveyed. As used herein, to be connected in “fluid communication” or “fluidic communication” or to be in “fluidic interconnection” means that a passage exists between the connected elements via which a fluid, including a gas and/or a liquid and/or any other non-solid matter, may pass from one connected element to another connected element.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the invention. The scope of the invention is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

1. A system comprising:
a first bracket configured to hold a cassette;
the cassette comprising gearing,
wherein the cassette is configured to adjust a window shade;
a second bracket comprising a holder; and
a secondary glazing configured to be held within the holder,
wherein the first bracket and the second bracket are configured to be mounted within a window shade pocket next to a first glazing.

2. The system of claim 1, wherein the secondary glazing includes one or more glazings.

3. The system of claim 1, further comprising a channel configured to provide a path for a cable from a motor that interfaces with the cassette.

4. The system of claim 1, wherein the first bracket and the second bracket are integrated together.

5. The system of claim 1, wherein the first glazing is a single pane window.

6. The system of claim 1, wherein at least a portion of the first bracket and the second bracket are sealed against the window shade pocket.

7. The system of claim 1, wherein the cassette further comprises a motor.

8. The system of claim 1, wherein the cassette further comprises at least one of a chain, a lever or a wand.

9. The system of claim 1, wherein the window shade is a cellular shade, tilt blind, louver shade or roller shade.

10. The system of claim 1, wherein the holder is a C-shaped clamp.

11. The system of claim 1, wherein the first glazing is on a first side of the second bracket with the holder and the first bracket with the cassette is on a second side of the second bracket with the holder.

12. The system of claim 1, wherein the second bracket with the holder is between the first glazing and the first bracket with the cassette.

13. The system of claim 1, wherein the first bracket with the cassette is between the first glazing and the second bracket with the holder.

14. The system of claim 1, wherein the second glazing is between the first glazing and the cassette.

15. The system of claim 1, wherein the cassette is between the first glazing and the second glazing.

16. The system of claim 1, wherein the second glazing is between the first glazing and the window shade.

17. The system of claim 1, wherein the window shade is between the first glazing and the second glazing.

18. The system of claim 1, wherein one or more rails in the window shade pocket receive at least one of the first bracket or the second bracket.

19. The system of claim 1, wherein one or more rails in the window shade pocket receive at least one of the cassette or the holder.
